(19) United States
(12) Patent Application Publication
(10) Pub. No.: US 2005/0106491 A1
(43) Pub. Date: May 19, 2005

(54) Heat sensitive recording material

(76) Inventors: John Barry Henshall, Manchester (GB); James Philip Taylor, Oldham (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/506,699

(22) PCT Filed: Feb. 25, 2003
(86) PCT No.: PCT/EP03/01900

(30) Foreign Application Priority Data
Mar. 6, 2002 (EP) 0240170.8

(51) Int. Cl. G03C 5/00

(52) U.S. Cl. 430/245

(57) ABSTRACT

Composition for heat sensitive recording material a) a colour former compound, b) a developer, which is different from the stabilizer used as component c), c) a stabilizer, selected from the group consisting of compounds having the formulae (I), (II) and (III), wherein the amount of the stabilizer is less than 5% by weight, based on the total weight of the composition, and a heat sensitive recording material comprising this composition and the use of this composition as heat-sensitive coloured image-forming layer in heat-sensitive materials.

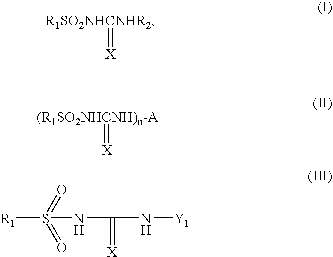

The present invention relates to a heat sensitive composition, a heat sensitive recording material comprising this composition and the use of this composition as heat-sensitive coloured image-forming layer in heat-sensitive materials.

Usually heat sensitive recording material comprises a supporting substrate, for example, a paper sheet, synthetic paper sheet or plastic resin film, and a thermosensitive coloured image-forming layer formed on a surface of the supporting substrate and comprising a colourless or pale coloured electron donative compound (colour forming compound or sometimes called colourless dye precursor), an organic electron acceptor (developer), and a binder.

Heat sensitive recording has conventionally been used as a system for recording transferred information through the mediation of heat, by utilizing a colour reaction between a colour forming compound and a developer.

The properties which are most desirable in a colour forming material, in addition to the effective development of colour, are thermal response, background whiteness and image stability, especially light fastness of the developed colour, heat and moisture fastness of the developed colour, oil fastness of the developed colour, plasticiser resistance of the developed colour and water fastness of the developed colour. In order to achieve these goals, it is known, for example, to add sensitizers to improve the performance of the heat sensitive composition with respect to the rate of image formation and to add stabilizers to improve resistance to oily and fatty substances and plasticisers.

For example, EP-A 620 122 discloses a thermosensitive recording material in which as a sensitizing additive an aromatic amide is used.

JP 07 047772 A discloses a heat-sensitive recording material, comprising a recording layer formed on a support, said recording layer comprising a colorless or pale color basic dye and a color developer, wherein said color developer in said recording layer comprises
I) an aromatic compound having in a molecule thereof a specific functional group represented by the formula: —SO₂NHCX—, wherein X represents an oxygen atom or a sulfur atom,
II) and a hydroxydiphenyl sulfone derivative.

It is taught in the specification that the content of the compound containing an —SO₂NHCX— group is generally 5 to 50% by weight, based on the dry weight of the recording layer, because if the content is less than 5% by weight, the developing ability may be unsatisfactory. Consequently, in the examples the amounts of the compounds containing an —SO₂NHCX— group is about 30% by weight, based on the dry weight of the recording layer.

JP 07 47772 A does not disclose explicitly a mixture of two or more color developers, in which two of them each contain at least one —SO₂NHCX-group, in particular no mixture is disclosed, in which one color developer containing an —SO₂NHCX— group is present in less than 5% by weight.

EP-A 535 887 describes a thermosensitive recording material which comprises a colour developing agent having at least two sulfonyl(thio)urea units per molecule. According to the specification (p. 9, I. 15-21), the amount of either this colour developing agent or of any other conventional colour developing compound is at least 5% in order to avoid unsatisfactory colour-forming performance.

However, a disadvantage of heat sensitive recording materials is the stability of the image in that the reaction of the colour former with the colour-developing agent is reversible and thus the resultant coloured images fade particularly towards light over a prolonged period of time. In addition, the stability of the image is lowered when it is stored under severe conditions, for example at elevated temperatures and/or humidity, or when the recording material is brought into contact with water, an oily or fatty substance or plasticisers.

Therefore, a need still exists to improve the above properties and to improve the archival capabilities of such recording materials. In particular, it is an object of the present invention to provide a heat sensitive composition for use in heat sensitive recording materials with improved properties, especially to provide an increase in image stability whilst maintaining or improving the background whiteness of the paper before imaging and the background whiteness of the undeveloped portion after imaging.

Accordingly, the claimed composition has been found. In addition, a heat sensitive recording material has been found, too, as well as the use of compounds I to III as stabilizers in heat sensitive recording materials.

The present invention relates to a heat sensitive recording material comprising
a) a colour former compound,
b) a developer, which is different from the stabilizer used as component c),
c) a stabilizer, selected from the group consisting of compounds having the formulae I, II and III, 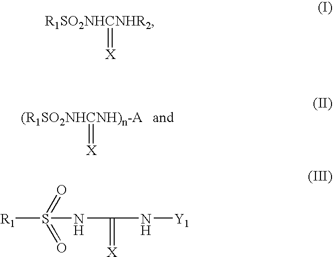
   wherein
R₁ stands for unsubstituted or substituted phenyl or naphthyl, C, —C₁₀alkyl, C₃-C₁₀cycloalkyl, wherein the carbon chains of the alkyl (i.e. at least two carbon atoms) and cycloalkyl groups may be interrupted by —O—, —S—, —NH-radicals, or
unsubstituted or substituted aralkyl having from seven to twelve carbon atoms,
R₂ stands for hydrogen, unsubstituted or substituted phenyl, naphthyl, C₁-C₂₀alkyl, unsubstituted or substituted aralkyl having from seven to twelve carbon atoms, or R₁ stands for —R₃-B-R₄, in which R₃ stands for phenylene or naphthylene, in particular for o-, m- or p-phenylene, preferably p-phenylene, or 1,2; 2,3; 1,4 or 1,5-naphthylene, preferably 1,5-naphthylene, and wherein B stands for —O—SO₂—, —SO₂—O— —NH—SO₂—, —SO₂—NH—, —S—SO₂—, —O—CO—, —O—CO—NH—, —NH—CO—, —NH—CO—O—, —S—CO—NH—, —S—CS—NH—, —CO—NH—SO₂—, —O—CO—, —NH—SO₂—, —NH═CH—, —CO—NH—CO—, —S—, —CO—, —O—, —SO₂—NH—CO—, —O—CO—O—, —CH₂—, —CH₂CH₂—, —SO₂—, —O—PO—(OR₄)₂, —CONH— and —COO—, preferably —O—SO₂—, —SO₂—O—, —SO₂—NH—, —S—SO₂—, —O—CO—, —SO₂—, —CH₂—, —O—CO—NH—, —CONH—, —O— and —COO—, more preferably —O—SO₂—, —SO₂—O—, —O—CO—, SO₂—, —O— and —SO₂—NH—, and most preferred —O—SO₂—, —O— and —COO—.
and R₄ stands for hydrogen, C₆-C₁₀aryl, preferably phenyl or naphthyl which can be unsubstituted or substituted one to three times by, for example, C₁-C₈alkyl, halogen-substituted C₁-C₈alkyl, C₁-C₈alkoxy-substituted C₁-C₈alkyl, C₁-C₈alkoxy, halogen-substituted C₁-C₈ alkoxy or halogen, preferred C₁-C₄alkyl and C₁-C₄alkoxy, preferred substituents are C₁-C₄ alkyl and halogen, in particular preferred are phenyl which is unsubstituted or substituted by C₁-C₈alkyl, halogen-substituted C₁-C₈alkyl, C₁-C₈alkoxy-substituted C₁-C₈alkyl, C₁-C₈alkoxy, halogen-substituted C₁-C₈alkoxy or halogen, and unsubstituted naphthyl, more preferred are phenyl which is unsubstituted or substituted by C₁-C₄alkyl or halogen, and naphthyl, especially phenyl which is unsubstituted or substituted by C₁-C₄alkyl, benzyl, unsubstituted, preferred, or substituted one to three times by C₁-C₈alkyl, halogen-substituted C₁-C₈alkyl, C₁-C₈alkoxy-substituted C₁-C₈alkyl, C₁-C₈alkoxy, halogen-substituted C₁-C₈alkoxy or halogen, preferred is unsubstituted benzyl, or C₁-C₂₀alkyl, preferably C₁-C₈alkyl, more preferably C₁-C₆alkyl, most preferred C₁-C₄alkyl, which can be unsubstituted, preferred, or substituted one to three times by, for example, C₁-C₈alkoxy, halogen, preferred halogen-substituted C₁-C₆alkyl, more preferred halogen-substituted C₁-C₄alkyl, phenyl or naphthyl, preferred phenyl-substituted C₁-C₆alkyl, or naphthyl-substituted C₁-C₆alkyl,
A represents a multivalent group having a valency of 2, 3 or 4, n represents an integer of 2, 3 or 4, and X stands for oxygen or sulphur,
Y₁ stands for a heterocyclic ring having from two to seven carbon atoms and from 1 to three atoms selected from the group consisting of oxygen, nitrogen and sulphur, which can be substituted one to three times with unsubstituted or substituted phenyl, C₁-C₂₀alkyl, C₁-C₈alkoxy, halogen or —SO₂R₆, R₆ stands for phenyl, which may be substituted one to three times with C₁-C₄alkyl, wherein the total number of carbon, oxygen, sulphur and nitrogen atoms of the heterocyclic ring is from 5 to 9,
   and wherein the amount of the stabilizer is less than 5% by weight, based on the total weight of the composition.

In a preferred embodiment R₁ as phenyl or naphthyl can be unsubstituted or substituted one to three times by, for example, C₁-C₈alkyl, preferably C₁-C₄alkyl, C₁-C₈alkoxy, preferably C₁-C₄alkoxy or halogen. In case R₁ stands for naphthyl, it is preferably unsubstituted. In case R₁ stands for phenyl, it is preferably substituted one, two or three times, especially by C₁-C₈alkyl, preferably C₁-C₄alkyl.

In another preferred embodiment R₁ as C₁-C₂₀ alkyl can be unsubstituted, preferred, or substituted one, two or three times by, for example C₁-C₈alkoxy, preferred C₁-C₄alkoxy, or halogen.

In another preferred embodiment, R₁ stands for C₃-C₁₀cycloalkyl. In still another embodiment, R₁ stands for C₂-C₂₀alkyl having at least one member selected from the group consisting of O, S and NH included in the backbone chain thereof, preferably it is unsubstituted, and in particular R₁ stands for the ethoxyethyl group. In another preferred embodiment, R₁ stands for aralkyl, preferably benzyl, which can be unsubstituted, preferred, or substituted one two or three times by, for example, C₁-C₄alkoxy.

Preferably, R₁ is phenyl, which is unsubstituted or substituted by C₁-C₈alkyl, C₁-C₈ alkoxy or halogen. Particular preferred are the substituted phenyl groups. Most preferred are phenyl groups, which are substituted by C₁-C₄ alkyl, in particular methyl.

In a preferred embodiment, R₂ as C₁-C₂₀alkyl can be unsubstituted, preferred, or substituted one, two or three times by, for example C₁-C₈alkoxy, preferred C₁-C₄alkoxy, or halogen. In another preferred embodiment, R₂ stands for phenyl or naphthyl that can be unsubstituted or substituted one, two or three times by, for example, C₁-C₈ alkyl, preferred C₁-C₄alkyl, halogen-substituted C₁-C₈ alkyl, C₁-C₈ alkoxy-substituted C₁-C₈ alkyl, halogen or phenyl. In case R₂ stands for naphthyl, naphthyl is preferred unsubstituted. In case R₂ stands for phenyl, the phenyl group is either unsubstituted or substituted by C₁-C₈ alkyl, preferably C₁-C₄alkyl, halogen-substituted C₁-C₈ alkyl, C₁-C₈ alkoxy-substituted C₁-C₈ alkyl, halogen, or phenyl, especially C₁-C₈ alkyl, halogen-substituted C₁-C₈ alkyl, or halogen. Preferably, R₂ stands for phenyl, which is unsubstituted or substituted one, two or three times by C₁-C₄ alkyl, or halogen. In case R₂ stands for aralkyl, the aralkyl group can be unsubstituted, preferred, or substituted one, two or three times by, for example, C₁-C₄alkyl, C₁-C₄alkoxy, or halogen.

C₁-C₂₀alkyl stands for methyl, ethyl, n-, i-propyl, n-, i-, sec.- or tert.-butyl, n-, i-, tert.-pentyl, n-hexyl, n-heptyl, n-octyl, 2-ethyl-hexyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, preferably C₁-C₄alkyl such as methyl, ethyl, n-, i-propyl, n-, i-, sec.- or tert.-butyl, n-, i-, tert.-pentyl, n-hexyl, n-heptyl, n-octyl, 2-ethyl-hexyl, more preferably for C₁-C₆alkyl such as for methyl, ethyl, n-, i-propyl, n-, i-, sec.- or tert.-butyl, n-, i-, tert.-pentyl, n-hexyl, and most preferred for C₁-C₄alkyl such as for methyl, ethyl, n-, i-propyl, n-, i-, sec.- or tert.-butyl.

C₁-C₈alkoxy stands for methoxy, ethoxy, n-, i-propoxy, n-butoxy, n-pentoxy, n-hexoxy, n-heptoxy, n-octoxy, preferred C₁-C₄alkoxy such as methoxy, ethoxy, n-, i-propoxy, n-butoxy.

C₃-C₁₀cycloalkyl stands for cyclopropyl, cyclobutyl, cyclopentyl, cyclohexyl, cycloheptyl, cyclooctyl, cyclononyl or cyclodecyl, preferably cyclohexyl.

C₆-C₁₀aryl stands for phenyl and naphthyl.

Halogen stands for fluorine, chlorine, bromine or iodine, preferably for chlorine.

In a preferred embodiment of this invention the weight ratio of stabilizer to colour former is in the range of from 0.05:1 to 1:1, preferably from 0.1:1 to 0.7:1, most preferred 0.45:1 to 0.55:1, in particular 0.5:1.

The weight ratio of developer to colour former usually is chosen in the range of from 1:1 to 5:1, preferably from 2:1 to 3:1.

The stabilisers of formula I are exemplified by but not limited to: N-(p-toluenesulphonyl)-N′-phenylurea, N-(p-toluenesulphonyl)-N′-(o-tolyl)urea, N-(p-toluenesulphonyl)-N′-(m-tolyl)urea, N-(p-toluenesulphonyl)-N′-(p-tolyl)urea, N-(p-toluenesulphonyl)-N′-(p-n-butylphenyl)urea, N-(p-toluenesulphonyl)-N′-(o-chlorophenyl)urea, N-(p-toluenesulphonyl)-N′-(m-chlorophenyl)urea, N-(p-toluenesulphonyl)-N′-(2,4-dichlorophenyl)urea, N-(p-toluenesulphonyl)-N′-benzylurea, N-(p-toluenesulphonyl)-N′-(1-naphthyl)urea, N-(p-toluenesulphonyl)-N′-[1-(2-methylnaphthyl)]urea, N-(p-toluenesulphonyl)-N′-(o-diphenyl)urea, N-(p-toluenesulphonyl)-N′-butylurea, N-(benzenesulphonyl)-N′-phenylurea, N-(p-chlorobenzenesulphonyl)-N′-phenylurea, N-(o-toluenesulphonyl)-N′-phenylurea, N-(p-toluenesulphonyl)-N′-methylurea, N-(p-toluenesulphonyl)-N′-ethylurea, N,N′-bis(p-toluenesulphonyl)urea, N-benzylsulphonyl-N′-phenylurea, N-(2-phenoxyethane)sulphonyl-N′-phenylurea, N-(4-methoxybenzyl)sulphonyl-N′-phenylurea, N-(2-(p-chlorophenyl)ethane)sulphonyl-N′-phenylurea, N-(p-biphenyl)sulphonyl-N′-butylurea, N-benzylsulphonyl-N′-benzylurea, N-benzylsulphonyl-N′-phenylthiourea, N-ethanesulphonyl-N′-1-naphthylurea, N-cyclohexanesulphonyl-N′-phenylurea, N-allylsulphonyl-N′-1-naphthylurea, N-(2-methoxyethanesulphonyl)-N′-biphenylurea, N-(2-tetrahydropyransulphonyl)-N′-1 naphthylurea, N-(2-allyloxyethanesulphonyl)-N′-1-naphthylurea, N-isopropanesulphonyl-N′-benzylurea, N-isopropanesulphonyl-N′-(4-methylbenzyl)urea, N-methanesulphonyl-N′-(4-chloro-1-naphthyl)urea, N-isopropanesulphonyl-N′-(4-chloro-1-naphthyl)urea, N-methanesulphonyl-N′-1-naphthyl-thiourea, N-(p-toluenesulphonyl)-N′-(p-methoxyphenyl)urea, N-(p-toluenesulphonyl)-N′-(m-hydroxyphenyl)urea, N-(p-toluenesulphonyl)-N′-(p-hydroxyphenyl)ᵤ rea, N-(p-toluenesulphonyl)-N′-(p-ethoxycarbonylphenyl)urea, N-(p-toluenesulphonyl)-N′-(2-phenoxyethyl)urea, N-benzylsulphonyl-N′-(2-phenoxyethyl)urea, N-benzylsulphonyl-N′-(p-methoxyphenyl)urea, N-(p-methoxybenzyl)sulphonyl-N′-(2-(p-chlorophenyloxy)ethyl)urea, N-methanesulphonyl-N′-(2-phenoxyethyl)urea, N-methanesulphonyl-N′-(4-methoxy-1-naphthyl)urea, N-(p-toluenesulphonyl)-N′-(3-n-butylaminosulphonylphenyl)urea, N-(p-toluenesulphonyl)-N′-(4-trimethylacetophenyl)urea, N-(benzenesulphonyl)-N′-(3-p-toluenesulphonyloxyphenyl)urea, N-(p-toluenesulphonyl)-N′-(3-p-toluenesulphonyloxyphenyl)urea, N-(p-toluenesulphonyl)-N′-(3-phenylsulphonyloxyphenyl)urea, N-(p-toluenesulphonyl)-N′-(2-p-toluenesulphonyloxyphenyl)urea, N-(p-toluenesulphonyl)-N′-(2-phenyl-sulphonyloxyphenyl)urea, N-(p-toluenesulphonyl)-N′-(4-benzoyloxyphenyl)urea, N-(p-toluenesulphonyl)-N′-(4-phenylsulphonyloxyphenyl)urea, N-(p-toluenesulphonyl)-N′-(4-acetoxyphenyl)urea, N-(p-toluenesulphonyl)-N′-(2-p-toluenesulphonyloxy-5-ethylsulphonyl phenyl)urea, N-(o-toluenesulphonyl)-N′-(3-p-toluenesulphonyloxyphenyl)urea, N-(4-chlorobenzenesulphonyl)-N′-(3-p-toluene-sulphonyloxyphenyl)urea, N-(p-toluenesulphonyl)-N′-(4-p-toluenesulphonyloxyphenyl)urea, N-(p-toluenesulphonyl)-N′-(3-butylsulphonyloxyphenyl)urea, N-(p-toluenesulphonyl)-N′-(2-methyl-4-p-toluenesulphonyloxyphenyl)urea, N-(p-toluenesulphonyl)-N′-(5-p-toluenesulphonyloxynapthyl)urea, N-(p-toluenesulphonyl)-N′-(4-p-tolyloxysulphonylphenyl)urea, N-(p-toluenesulphonyl)-N′-(3-octylsulphonyloxyphenyl)urea, N-(p-toluenesulphonyl)-N′-(3-Hexadecylsulphonyloxyphenyl)urea, N-(octyisulphonyl)-N′-(3-p-toluenesulphonyloxyphenyl)urea, N-(p-toluenesuiphonyl)-N′-(4-phenylsulphonyloxyphenyl)urea, N-(phenylsulphonyl)-N′-(3-(p-toluenesulphonyloxy)phenyl)urea, N-(4-chlorophenylsulphonyl)-N′-(3-trimethylacetoxyphenyl)urea, N-(p-toluenesulphonyl)-N′-(4-(p-toluenesulphonyloxy)phenyl)urea, N-(p-toluenesulphonyl)-N′-(4-acetophenyl)urea, N-(p-toluenesulphonyl)-N′-(4-acetamidosulphonylphenyl)urea, N-(p-toluenesulphonyl)-N′-(3-(ethoxycarbonyloxy)phenyl)urea, N-(p-toluenesulphonyl)-N′-(3-(ethoxycarbamyl)phenyl)urea, N-(p-toluenesulphonyl)-N′-(3-(2-napthyl sulphonyloxy)phenyl)urea, N-(p-toluenesulphonyl)-N′-(4-benzoylphenyl)urea, N-(p-toluenesulphonyl)-N′-(3-(4-toluenesulphonylamino)phenyl)urea, N-(p-toluenesulphonyl)-N′-(3-acetaminophenyl)urea, N-(4-chlorophenylsulphonyl)-N′-(4-trimethylacetamidophenyl)urea, N-(benzenesulphonyl)-N′-(4-trimethylacetamidophenyl)urea, N-(4-chlorophenylsulphonyl)-N′-(2-(p-toluenesulphonyloxy)phenyl)urea, N-(p-toluenesulphonyl)-N′-(3-(N,N-di-p-toluenesulphonyl)aminophenyl)urea, N-(benzenesulphonyl)-N′-(2-(p-toluenesulphonyloxy)phenyl)urea, N-(4-chlorophenylsulphonyl)-N′-(4-acetamidosulphonylphenyl)urea, N-(p-toluenesulphonyl)-N′-(3-(diphenylphosphinyl)phenyl)urea.

The multivalent group A of formula 11 is preferably selected from the group consisting of
a] divalent carbonyl, thiocarbonyl and sulphonyl groups;
b] multivalent aliphatic hydrocarbon groups;
c] multivalent heteroatom containing aliphatic groups derived from aliphatic hydrocarbon compounds having at least one heteroatom located in a backbone chain per molecule thereof;
d] multivalent aliphatic groups derived from aliphatic hydrocarbon compounds having at least one member selected from the group consisting of carbonyl, thiocarbonyl, imide, imino and sulphonyl groups and ester structures located in a backbone chain per molecule thereof;
e] multivalent aliphatic aromatic (aroaliphatic) groups derived from aliphatic hydrocarbon compounds having at least one member selected from the group consisting of unsubstituted and substituted aromatic hydrocarbon groups, located in a backbone chain per molecule thereof;
f] multivalent organic groups derived from aliphatic hydrocarbon compounds having at least one member selected from the group consisting of unsubstituted and substituted heterocyclic groups, located in a backbone chain per molecule thereof;
g] multivalent aromatic groups, derived from substituted and unsubstituted aromatic hydrocarbon compounds.
h] multivalent heterocyclic groups derived from unsubstituted and substituted heterocyclic compounds; and
i] multivalent organic groups derived from organic compounds in which two or more aromatic or heterocyclic groups are bonded to each other through one or more multivalent groups selected from the above mentioned groups a] to d].

Typical multivalent groups standing for A in formula II are as follows: 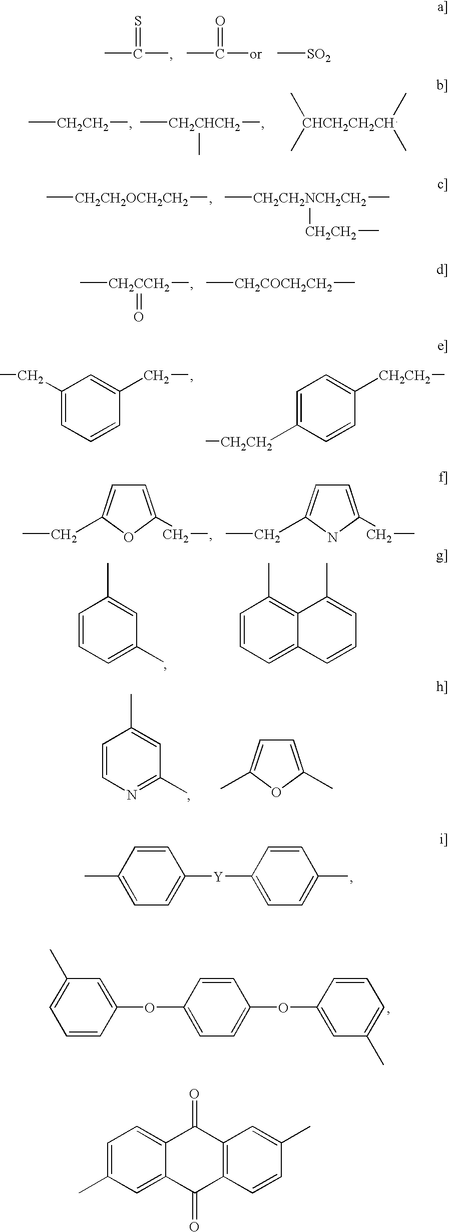
wherein Y₂ is represented by —SO₂—, —C(CH₃)—, —CH₂— or —O—
X is either an oxygen or sulphur atom, especially an oxygen atom and
n is an integer 1, 2 or 3, preferably 1 or 2.

The stabilisers of formula 11 are exemplified by but not limited to: bis(p-methoxybenzenesulphonylaminocarbonylamino)ketone, 1,2-bis(p-methoxybenzenesulphonylaminocarbonylamino)ethane, 1,5-bis(p-methoxybenzenesulphonylaminocarbonylamino)-3-oxapentane, 1,3-bis(p-methoxybenzenesulphonylaminocarbonylamino)-2-propane, 1,S-bis(p-methoxybenzenesulphonylaminocarbonylamino)-3-(2-(p-methoxybenzenesulfonylaminocarbonylamino)ethyl)-3-azapentane, 1,3-bis(p-methoxybenzenesulphonylaminocarbonylaminomethyl)benzene, 4,4′-bis(p-methoxybenzenesulphonylaminocarbonylamino) diphenylmethane, 4,4′-bis(p-methoxybenzenesulphonylaminothiocarbonylamino), diphenylmethane, 4,4′-bis(p-nitrobenzenesulphonylaminocarbonylamino) diphenylmethane, 4,4′-bis(m-trifluoromethylmethoxybenzenesulphonylaminocarbonylamino)diphenylmethane, 4,4′-bis(p-phenoxybenzenesulphonylaminocarbonylamino)diphenylmethane, 4,4′-bis(p-benzyloxybenzenesulphonyl aminocarbonylamino)diphenylmethane, 4,4′-bis(p-acetylbenzenesulphonyl aminocarbonylamino)diphenylmethane, 4,4′bis(p-benzoylbenzenesulphonyl aminocarbonylamino)diphenylmethane, 4,4′-bis(p-allyloxybenzenesulphonyi aminocarbonylamino)diphenylmethane, 4,4′-bis(p-allylbenzenesulphonyl aminocarbonylamino)diphenylmethane, 4,4′-bis(p-ethyny-benzenesulphonyl aminocarbonylamino)diphenylmethane, 4,4′-bis(p-cyclohexylbenzene sulphonylaminocarbonylamino)diphenylmethane, 4,4′-bis(p-phenylbenzenesuiphonylaminocarbonylamino)diphenylmethane, 4,4′-bis(p-benylbenzenesulphonylaminocarbonylamino) diphenylmethane, 4,4′-bis(o-methoxybenzenesulphonylaminocarbonylamino) diphenylmethane, 4,4′-bis(p-ethoxybenzenesulphonylaminothiocarbonylamino)diphenylmethane, 2,2-bis(4′-(p-methoxybenzenesulphonylaminocarbonylamino)phenyl)propane, 13,2-bis(4′-(p-ethoxybenzenesulphonylaminocarbonylamino)phenyloxy)ethane, 3,3′-bis(p-methoxybenzenesulphonylaminocarbonylamino)diphenylsulphone, 4,4′-bis(p-methoxybenzeneesulphonylaminocarbonylamino)diphenylether, 2,5-bis(p-methoxybenzenesulphonylaminocarbonylaminomethyl)furan, 1,3-bis(p-methoxybenzenesulphonylaminocarbonylamino)benzene, 1,5-bis(p-ethoxybonzenetoluenesulphonylaminocarbonylamino)naphthalene, bis(p-toluenesulphonylaminocarbonyamino)ketone, 1,2-bis(p-toluenesulphonylaminocarbonylamino)ethane, 1,1,6,6-tetra(p-toluenesulphonylaminocarbonylamino)heptane, 1,5-bis(p-toluenesulphonyiaminocarbonylamino)-3-oxapentane, 1,5-bis(p-toluenesulphonylaminocarbonylamino)-3-thiopentane, 1,3′-bis(p-toluenesulphonylaminocarbonylamino)-2-propanone, 1,5-bis(p-toluenesulphonylaminocar bonylamino)3-[2′(p-toluenesulphonylaminocarbonyl-amino)ethyl]-3-azapentane, 1,3-bis(p-toluenesulphonylaminocarbonylamino)methylbenzene, 1,4-bis(p-toluenesulphonylaminocarbonylamino)methylbenzene, 4,4′-bis(p-toluenesulphonylaminocarbonylamino)diphenylmethane, 4,4′-bis(o-toluenesulphonylaminocarbonylamino))diphenylmethane, 4,4′-bis(benzenesulphonylamniocarbonylamino)-diphenylmethane, 4,4′-bis(1-naphthalenesulphonylaminocarbonylamino)-diphenylmethane, 2,2-bis[4′-(p-toluenesulphonylaminocarbonylamino)phenyl]propane, 1,2-bis[4′-(p-toluenesulphonylaminocarbonylamino)phenyloxy]ethane, 1,4-bis[3′-(p-toluenesulphonylaminocarbonylamino)phenyloxy]ethane, 2,5-bis(p-toluenesulphonylaminocarbonylamino)methylfuran, 1,3-bis(p-toluenesulphonylaminocarbonylamino)benzene, 1,4-bis(p-toluenesulphonylaminocarbonylamino)benzene, 1,5-bis(p-toluenesulphonylaminocarbonylamino)naphthalene, 1,8-bis(p-toluenesulphonylaminocarbonylamino)naphthalene, 4,4′-bis(p-toluenesulphonylaminocarbonylamino)diphenylether, 3,3′-bis(p-toluenesulphonylaminocarbonylamino)diphenylsulphone, 4,4′-bis(p-toluenesulphonylaminocarbonylamino)diphenylsulphone, 2,4-bis(p-toluenesulphonylaminocarbonylamino)toluene, 2,6-bis(p-toluenesulphonylaminocarbonylamino)toluene, 4,4′-bis(p-toluenesulphonylaminocarbonylamino)diphenylsulphide, 3,4′-bis(p-toluenesulphonylaminocarbonylamino)diphenylether, 4,4-bis(methanesulphonylaminocarbonylamino)diphenylmethane, 4,4′-bis(ethanesulphonylaminocarbonylamino)diphenylmethane, 4,4′-bis(isopropanesulphonylaminocarbonylamino)diphenylmethane, 4,4′-bis(trifluoromethanesulphonylaminocarbonylamino)diphenylmethane, 4,4′-bis(cyclohexanesulphonylaminocarbonylamino)diphenylmethane, 4,4′-bis(allylsulphonylaminocarbonylamino)diphenylmethane, 4,4′-bis(2-methoxyethanesulphonylaminocarbonylamino)diphenylmethane, 4,4′-bis(2-tetrahydropyransulphonylaminocarbonylamino)diphenylmethane, 4,4′-bis(2-allyloxyethanesulphonylaminocarbonylamino)diphenylmethane, 1,5-bis(methanesulphonylaminocarbonylamino)naphthalene, 1,3-bis(methanesulphonylaminocarbonylamino)benzene, 4,4′-bis(methanesulphonylaminocarbonylamino)diphenylether, 4,4′-bis(methanesulphonylaminothiocarbonylamino) diphenylmethane, 4,4′-bis(benzylsulphonylaminocarbonylamino)diphenylmethane, 4,4′-bis(p-methylbenylsulphonylaminocarbonylamino)diphenylmethane, 4,4′-bis(p-methoxybenylsulphonylaminocarbonylamino)diphenylmethane, 4,4′-bis(p-chlorobenylsulphonylaminocarbonylamino)diphenylmethane, 4,4′-bis(2-phenoxyethylsulphonylaminocarbonylamino)diphenylmethane, 4,4′-bis(2-(p-methoxyphenoxy)ethylsulphonylaminocarbonylamino)diphenylmethane, 4,4′-bis(benzylsulphonylaminocarbonylamino) diphenylether, 1,5-bis(benzylsulphonylaminocarbonylamino)naphthalene, 1,3-bis(benzylsulphonylaminocarbonylamino)benzene, 4,4′-bis(benzylsulphonylaminothiocarbonylamino)diphenylmethane, 1,3-bis(p-toluenesulphonylaminocarbonylamino)-2-methylbenzene, 1,4-bis(p-toluenesulphonylaminocarbonylamino)-2,5-dimethylbenzene, 4,4′-bis(p-toluenesulphonylaminocarbonylamino)-3,3′-dimethyldiphenylmethane, 4,4′-bis(p-toluenesulphonylaminothiocarbonyl amino)-3,3′-dimethyldiphenylmethane, 4,4′-bis(o-toluenesu Iphonylamino carbonylamino)-3,3′-dimethyldiphenylmethane, 4,4′-bis(benzenesulphonyl aminocarbonylamino)-3,3′-dimethyldiphenylmethane, 4,4′-bis(p-toluenesulphonylaminocarbonylamino)-3,3′-diethyldiphenylmethane, 4,4′-bis(p-toluenesulphonylaminocarbonylamino)-3,3′-dichloro diphenylmethane, 4,4′-bis(p-toluenesulphonylaminocarbonylamino)-3,3′,5,5′-tetramethyldiphenylmethane, 4,4′-bis(p-toluenesulphonylaminocarbonyl amino)-3,3′,5,5′-tetraethyldiphenylmethane, 4,4′-bis(p-toluenesulphonyl aminocarbonylamino)-3,3′-dimethoxylbiphenyl, 4,4′-bis(p-toluenesulphonylaminocarbonylamino)-3,3′-dimethylbiphenyl, 4,4′-bis(p-toluenesulphonylaminocarbonylamino)-2,2′,5,5′-tetrachlorobiphenyl, 2,8-dimethyl-3,7-bis(p-toluenesulphonylaminocarbonylamino) dibenzothiophene-5,5-dioxide, 4,4′-bis(p-toluenesulphonylaminocarbonylamino)-3,3′-dimethyldiphenylether, 2,5-bis(p-toluenesulphonylaminocarbonylaminomethyl)-3,5-diethylfuran.

Y₁ can stand for the following preferred heterocyclic rings: thiazole, pyrazole, isoxazole, pyridine, pyrimidine, pyrazine, 1,2,4-triazine, indole, benzimidazole, benzothiazole, quinoline and benzoxazole.

The stabilisers of formula III are exemplified by but not limited to: N-(p-toluenesulphonyl)-N′-(pyrid-3-yl)urea, N-(p-toluenesulphonyl)-N′-(6-methylpyridin-2-yl)urea, N-(p-toluenesulphonyl)-N′-(5-methylisoxazol-3-yl)urea, N-(p-toluenesulphonyl)-N′-((1,2-dihydro-1,5-dimethyl-2-phenyl-3H-pyrazyol-3-one)₄-yl)urea, N-(p-toluenesulphonyl)-N′-(I.H.-indazol-6-yl)urea, N-(p-toluenesulphonyl)-N′-(4,6-dimethylpyrimidin-2-yl)urea, N-(p-toluenesulphonyl)-N′-(benzothiazol-2-yl)urea, N-(p-toluenesulphonyl)-N′-(thiazol-2-yl)urea, N-(p-toluenesulphonyl)-N′-(5-methyl-1.H.-pyrazol-3-yl)urea, N-(p-toluenesulphonyl)-N′-(benzimidazol-2-yl)urea, N-(p-toluenesulphonyl)-N′-(pyrimidin-2-yl)urea, N-(p-toluenesulphonyl)-N′-(6-methanesulphonylbenzothiazol-2-yl)urea, N-(p-toluenesulphonyl)-N′-[4-(6-methylbenzothiazol-2yl)phenyl]urea, N-(p-toluenesulphonyl)-N′-(1.H.-[1,2,4]triazol-3-yl)urea. All the exemplified stabilisers can be used singly or as a mixture with other stabilisers.

The stabilisers of formulae I, II and III are either known or can be prepared by the methods disclosed in WO 00/35679 and references therein.

The colour forming compounds are, for example, triphenylmethanes, lactones, benzoxazines, spiropyrans or preferably fluorans.

Preferred colour formers include but are not limited to; 3-diethylamino-6-methylfluoran, 3-dimethylamino-6-methyl-7-anilinofluoran, 3-diethylamino-6-methyl-7-anilinofluoran, 3-diethylamino-6-methyl-7-(2,4-dimethylanilino) fluoran, 3-diethylamino-6-methyl-7-chlorofluoran, 3-diethylamino-6-methyl-7-(3-trifluoromethylanilino) fluoran, 3-diethylamino-6-methyl-7-(2-chloroanilino) fluoran, 3-diethylamino-6-methyl-7-(4-chloroanilino) fluoran, 3-diethylamino-6-methyl-7-(2-fluoroanilino) fluoran, 3-diethylamino-6-methyl-7-(4-n-octylanilino) fluoran, 3-diethylamino-7-(4-n-octylanilino) fluoran, 3-diethylamino-7-(n-octylamino) fluoran, 3-diethylamino-7-(dibenzylamino) fluoran, 3-diethylamino-6-methyl-7-(dibenzylamino) fluoran, 3-diethylamino-6-chloro-7-methylfluoran, 3-diethylamino-7-t-butylfluoran, 3-diethylamino-7-carboxyethylfluoran, 3-diethylamino-6-chloro-7-anilinofluoran, 3-diethylamino-6-methyl-7-(3-methylanilino) fluoran, 3-diethylamino-6-methyl-7-(4-methylanilino) fluoran, 3-diethylamino-6-ethoxyethyl-7-anilinofluoran, 3-diethylamino-7-methylfluoran, 3-diethylamino-7-chlorofluoran, 3-diethylamino-7-(3-trifluoromethylanilino) fluoran, 3-diethylamino-7-(2-chloroanilino) fluoran, 3-diethylamino-7-(2-fluoroanilino) fluoran, 3-diethylamino-benzo[a]fluoran, 3-diethylamino-benzo[c]fluoran, 3-dibutylamino-7-dibenzylaminofluoran, 3-dibutylamino-7-anilinofluoran, 3-diethylamino-7-anilinofluoran, 3-dibutylamino-6-methyl fluoran, 3-dibutylamino-6-methyl-7-anilinofluoran, 3-dibutylamino-6-methyl-7-(2,4-dimethylanilino) fluoran, 3-dibutylamino-6-methyl-7-(2-chloroanilino) fluoran, 3-dibutylamino-6-methyl-7-(4-chloroanilino) fluoran, 3-dibutylamino-6-methyl-7-(2-fluoroanilino) fluoran, 3-dibutylamino-6-methyl-7-(3-trifluoromethylanilino) fluoran, 3-dibutylamino-6-ethoxyethyl-7-anilinofluoran, 3-dibutylamino-6-chloro-anilinofluoran, 3-dibutylamino-o-methyl-7-(4-methylanilino) fluoran, 3-dibutylamino-7-(2-chloroanilino) fluoran, 3-dibutylamino-7-(2-fluoroanilino) fluoran, 3-dipentylamino-6-methyl-7-anilinofluoran, 3-dipentylamino-6-methyl-7-(2-chloroanilino) fluoran, 3-dipentylamino-6-methyl-7-(4-chloroanilino) fluoran 3-dipentylamino-7-(3-trifluoromethylanilino) fluoran, 3-dipentylamino-6-chloro-7-anilinofluoran, 3-dipentylamino-7-(4-chloroanilino) fluoran, 3-pyrrolidino-6-methyl-7-anilinofluoran, 3-piperidino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-(N-ethyl-N-isoamylamino)-6-chloro-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-(N-butyl-N-isoamylamino)-6-methyl-7-anilinofluoran, 3-(N-isopropyl-N-3-pentylamino)-6-methyl-7-anilinofluoran, 3-(N-ethyl-N-ethoxypropylamino)-6-methyl-7-anilinofluoran, 3-cyclohexylamino-6-chlorofluoran, 2-methyl-6-p-(p-dimethylaminophenyl)aminoanilinofluoran, 2-methoxy-6-p-(p-dimethylaminophenyl)aminoanilinofluoran, 2-chloro-3-methyl-6-p-(p-phenylaminophenyl)aminoanilinofluoran, 2-diethylamino-6-p-(p-dimethylaminophenyl)aminoanilinofluoran, 2-phenyl-6-methyl-6-p-(p-phenylaminophenyl)aminoanilinofluoran, 2-benyl-6-p-(p-phenylaminophenyl)aminoanilinofluoran, 3-methyl-6-p-(p-dimethylaminophenyl)aminoanilinofluoran, 3-diethylamino-6-p-(p-diethylaminophenyl)aminoanilinofluoran, 3-diethylamino-6-p-(p-dibutylaminophenyl)aminoanilinofluoran, 2,4-dimethyl-6-[(4-dimethylamino)anilino]fluoran, 3-[(4-dimethylaminophenyl)amino]-5,7-dimethylfluoran, 3,6,6′-tris(dimethylamino)spiro[fluorene-9,3′-phthalide], 3,6,6′-tris(diethylamino)spiro[fluorene-9,3′-phthalide], 3,3-bis(p-dimethylaminophenyl)-6-dimethylaminophthalide, 3,3-bis(p-dimethylaminophenyl)phthalide, 3,3-bis-[2-(p-dimethylaminophenyl)-2-(p-methoxyphenyl)ethenyl-4,5,6,7-tetrabromophthalide, 3,3-bis-[2-(p-dimethylaminophenyl)-2-(p-methoxyphenyl)ethenyl-4,5,6,7-tetrachlorophthalide, 3,3-bis[1,1-bis(4-pyrrolidinophenyl)ethylene-2-yl]-4,5,6,7-tetrabromophthalide, 3,3-bis-[1-(4-methoxyphenyl)-1-(4-pyrridinophenyl)ethylene-2-yl]-4,5,6,7-tetrachlorophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)-4-azaphthalide, 3-(4-cyclohexylethylamino-2-methoxyphenyl)-3-(1-ethyl-2-methylindole-3-yl)-4-azaphthalide, 3,3-bis(1-ethyl-2-methylindole-3-yl) phthalide, 3,3-bis(1-octyl-2-methylindole-3-yl) phthalide, mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine, 4,4′-[1-methylethylidene)bis(4,1-phenyleneoxy-4,2-quinazolinediyl)]bis[N,N-diethylbenzenamine], bis(N-methyldiphenylamine)-4-yl-(N-butylcarbazole)-3-yl-methane and mixtures thereof.

All of the above colour forming compounds can be used singly or as a mixture with other colour forming compounds; or they may also be used together with further black colour forming compounds.

Highly preferred are 3-diethylamino-6-methyl-7-anilinofluoran, 3-diethylamino-6-methyl-7-(3-methylanilino) fluoran, 3-diethylamino-6-methyl-7-(2,4-dimethylanilino) fluoran, 3-dibutylamino-6-methyl-7-anilinofluoran, 3-dipentylamino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-isoamylamino)-6-methyl-7-anilinofluoran, 3-diethylamino-6-chloro-7-anilinofluoran, 3-dibutylamino-7-(2-chloroanilino)fluoran, 3-(N-ethyl-N-p-toluidino)-6-methyl-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-N-ethyl-N-ethoxypropylamino-6-methyl-7-anilinofluoran, 2,4-dimethyl-6-[(4-dimethylamino)anilino]fluoran and mixtures thereof.

It is also possible to use solid solutions comprising at least two colour forming compounds as described in PCT Patent Application 00/12318.

The monophase solid solutions can be used singly or as a mixture with other colour forming compounds such as triphenylmethanes, lactones, fluorans, benzoxazines and spiropyrans; or they may also be used together with further black colour forming compounds. Examples of such other colour forming compounds are given hereinbefore.

In addition, the inventive composition contains a developer (component b), which is different from the sensitizer used as component c). Such developers are exemplified by, but not limited to: 4,4′-isopropylidene bisphenol, 4,4′-sec-butylidene bisphenol, 4,4′-cyclohexylidene bisphenol, 2,2-bis-(4-hydroxyphenyl)-4-methylpentane, 2,2-dimethyl-3,3-di(4-hydroxyphenyl)butane, 2,2′-dihydroxydiphenyl, 1-phenyl-1,1-bis(4-hydroxyphenyl)butane, 4-phenyl-2,2-bis(4-hydroxyphenyl)butane, 1-phenyl-2,2-bis(4-hydroxyphenyl)butane, 2,2-bis(4′-hydroxy-3′-methylphenyl)-4-methylpentane, 2,2-bis(4′-hydroxy-3′-tert-butylphenyl)-4-methylpentane, 4,4′-sec-butylidene-bis (2-methylphenol), 4,4′-isopropylidene-bis (2-tert-butylphenol), 2,2-bis(4′-hydroxy-3′-isopropylphenyl)-4-methylpentane, allyl-4,4-bis (4′-hydroxyphenyl) pentanoate, propargyl-4,4-bis(4′-hydroxyphenyl) pentanoate, n-propyl-4,4-bis (4′-hydroxyphenyl) pentanoate, 2,4-bis (phenylsulfonyl) phenol, 2-(4-methylsulfonyl)-4-(phenylsulfonyl) phenol, 2-(phenylsulfonyl)-4-(4-methylsulfonyl) phenol, 2,4-bis (4-methylphenylsulfonyl) phenol, pentamethylene-bis(4-hydroxybenzoate), 2,2-dimethyl-3,3-di(4-hydroxyphenyl)pentane, 2,2-di(4-hydroxyphenyl)hexane, 4,4′-dihydroxydiphenyl thioether, 1,7-di(4-hydroxyphenylthio)-3,5-dioxaheptane, 2,2′-bis(4-hydroxyphenylthio)diethyl ether, 4,4′-dihydroxy-3,3′-dimethylphenyl thioether; benzyl-4-hydroxybenzoate, ethyl-4-hydroxybenzoate, propyl-4-hydroxybenzoate, isopropyl-4-hydroxybenzoate, butyl-4-hydroxybenzoate, isobutyl-4-hydroxybenzoate, 4,4′-dihydroxydiphenyl sulfone, 2,4′-dihydroxydiphenyl sulfone, 4-hydroxy-4′-methyldiphenyl sulfone, 4-hydroxy-4′-isopropoxydiphenyl sulfone, 4-hydroxy-4′-butoxydiphenyl sulfone, 4,4′-dihydroxy-3,3′-diallyldiphenyl sulfone, 3,4-dihydroxy-4′-methyldiphenyl sulfone, 4,4′-dihydroxy-3,3′,5,5′-tetrabromodiphenyl sulfone, 4,4′-bis (p-toluenesulphonylaminocarbonylamino) diphenylmethane, N-p-toluenesulphonyl-N′-phenyl urea, N-p-toluenesulphonyl-N′-[3-O-p-toluenesulphonyl]phenyl urea, dimethyl 4-hydroxyphthalate, dicyclohexyl 4-hydroxyphthalate, diphenyl 4-hydroxyphthalate, 4-[2-(4-methoxyphenyloxy)ethyloxy]salicylate, 3,5-di-tert-butylsalicylic acid, 3-benzyl salicylic acid, 3-(a-methylbenzyl) salicylic acid, 3-phenyl-5-(α,α-dimethylbenzyl) salicylic acid, 3,5-di-α-methylbenzyl salicylic acid; metal salts of salicylic acid, 2-benzylsulfonylbenzoic acid, 3-cyclohexyl-4-hydroxybenzoic acid, zinc benzoate, zinc 4-nitrobenzoate, 4-(4′-phenoxybutoxy)phthalic acid, 4-(2′-phenoxyethoxy)phthalic acid, 4-(3′-phenylpropyloxy)phthalic acid, mono (2-hydroxyethyl)-5-nitro-isophthalic acid, 5-benzyloxycarbonyl isophthalic acid, 5-(1′-phenylethanesulfonyl) isophthalic acid, bis(1,2-dihydro-1,5-dimethyl-2-phenyl-3H-pyrazol-3-one-O)bis(thiocyanato-N) zinc and mixtures thereof.

In a preferred embodiment, the inventive composition can contain a sensitiser. The weight ratio of sensitiser:colour former usually is chosen in the range from 0.5:1 to 3.0:1, preferably 1:1 to 2:1.

Representative examples of sensitiser are stearamide, methylol stearamide, p-benzylbiphenyl, m-terphenyl, 2-benzyloxynaphthalene, 4-methoxybiphenyl, dibenzyl oxalate, di(4-methylbenzyl) oxalate, di(4-chlorobenzyl) oxalate, dimethyl phthalate, dibenzyl terephthalate, dibenzyl isophthalate, 1,2-diphenoxyethane, 1,2-bis(4-methylphenoxy) ethane, 1,2-bis(3-methylphenoxy) ethane, 4,4′-dimethylbiphenyl, phenyl-1-hydroxy-2-naphthoate, 4-methylphenyl biphenyl ether, 1,2-bis(3,4-dimethylphenyl) ethane, 1,4-diethoxynaphthalene, 1,4-diacetoxybenzene, 1,4-diproprionoxybenzene, o-xylylene-bis(phenyl ether), 4-(m-methylphenoxymethyl) biphenyl, p-hydroxyacetanilide, p-hydroxybutyranilide, p-hydroxynonananilide, p-hydroxylauranilide, p-hydroxyoctadecananilide.

The above sensitisers are known or can be prepared according to known methods.

Another embodiment relates to a heat sensitive recording material which comprises a sheet substrate and a heat sensitive coloured image-forming layer formed on the surface of the supporting substrate, comprising the inventive composition, a binder and if needed other additives.

Usually the binder is added in an effective amount. As a rule the weight ratio of binder:colour former is chosen in the range of from as 0.5:1 to 4:1, preferably 1:3.5.

Representative binders used for the heat sensitive recording material include polyvinyl alcohol (fully and partially hydrolysed), carboxy, amide, sulfonic and butyral modified polyvinyl alcohols, derivatives of cellulose such as hydroxyethyl cellulose, methyl cellulose, ethyl cellulose, carboxymethyl cellulose and acetyl cellulose, copolymer of styrene-maleic anhydride, copolymer of styrene-butadiene, polyvinyl chloride, polyvinyl acetate, polyacrylamide, polyamide resin and mixtures thereof.

Exemplary fillers, which can be used include calcium carbonate, kaolin, calcined kaolin, aluminium hydroxide, talc, titanium dioxide, zinc oxide, silica, polystyrene resin, urea-formaldehyde resin, hollow plastic pigment and mixtures thereof.

Representative lubricants for use in heat sensitive recording materials include stearamide, methylene bisstearamide, polyethylene, carnauba wax, paraffin wax, zinc stearate or calcium stearate and mixtures thereof.

Other additives can also be employed, if necessary. Such additives are for example fluorescent whitening agents and ultraviolet absorbers. The ultraviolet absorbers may be employed in either the thermosensitive colouring layer or in a protective layer, and if desired, may be used in microencapsulated form in the protective layer.

Representative examples of ultraviolet absorbers that may be used in the invention include phenyl salicylate, p-tert-butylphenyl salicylate, p-octylphenyl salicylate and like salicylic acid type ultraviolet absorbers:
2,4-Dihydroxybenzophenone, 2-hydroxy-4-methoxybenzophenone, 2-hydroxy-4-octyloxybenzophenone, 2-hydroxy-4-dodecyloxybenzophenone, 2,2′-dihydroxy-4-methoxybenzophenone, 2,2′-dihydroxy-4,4′-dimethoxybenzophenone, 2-hydroxy-4-methoxy-5-sulfobenzophenone and like benzophenone type ultraviolet absorbers; 2-Ethylhexyl-2-cyano-3,3-diphenylacrylate, ethyl-2-cyano-3,3-diphenylacrylate and like cyanoacrylate type ultraviolet absorbers;
Bis(2,2,6,6-tetramethyl-4-piperidyl) sebacate, bis(2,2,6,6-tetramethyl-4-piperidyl) succinate, bis(1,2,2,6,6-pentamethyl-4-piperidyl)-2-(3,5-di-tert-butyl-4-hydroxybenyl)-2-n-butyl malonate and like hindered amine type ultraviolet absorbers;
2-(2′-Hydroxyphenyl) benzotriazole, 2-(2′-hydroxy-5′-methylphenyl) benzotriazole, 2-(2′-hydroxy-5′-tert-butylphenyl)benzotriazole, 2-(2′-hydroxy-3,5′-di-tert-butylphenyl) benzotriazole, 2-(2′-hydroxy-3′-tert-butyl-5′-methylphenyl)-5-chlorobenzotriazole, 2-(2′-hydroxy-3,5′-di-tert-butylphenyl)-5-chlorobenzotriazole, 2-(2′-hydroxy-3,5′-di-tert-butylphenyl)-5-tert-butylbenzotriazole, 2-(2′-hydroxy-3,5′-di-tert-amylphenyl) benzotriazole, 2-(2′-hydroxy-3,5′-di-tert-amylphenyl)-5-tert-amylbenzotriazole, 2-(2′-hydroxy-3,5′-di-tert-amylphenyl)-5-methoxybenzotriazole, 2-[2′-hydroxy-3′-(3″,4″,5″,6″-tetrahydrophthalimidomethyl)-5′-methylphenyl]benzotriazole, 2-(2′-hydroxy-5′-tert-octylphenyl)benzotriazole, 2-(2′-hydroxy-3′-sec-butyl-5′-tert-butylphenyl) benzotriazole, 2-(2′-hydroxy-3′-tert-amyl-5′-phenoxyphenyl)-5-methylbenzotriazole, 2-(2′-hydroxy-5′-n-dodecylphenyl) benzotriazole, 2-(2′-hydroxy-5′-sec-octyloxyphenyl)-5-phenylbenzotriazole, 2-(2′-hydroxy-3′-tert-amyl-5′-phenylphenyl)-5-methoxybenzotriazole, 2-[2′-hydroxy-3′,5′-bis(α,α-dimethylbenzyl)-phenyl]benzotriazole and like benzotriazole ultraviolet absorbers;
2-(2′-Hydroxy-3′-dodecyl-5′-methylphenyl) benzotriazole, 2-(2′-hydroxy-3′-undecyl-5′-methylphenyl) benzotriazole, 2-(2′-hydroxy-3′-tridecyl-5′-methylphenyl) benzotriazole, 2-(2′-hydroxy-3′-tetradecyl-5′-methylphenyl) benzotriazole, 2-(2′-hydroxy-3′-pentadecyl-5′-methylphenyl) benzotriazole, 2-(2′-hydroxy-3′-hexaadecyl-5′-methylphenyl) benzotriazole, 2-[2′-hydroxy-4′-(2″-ethylhexyl)oxyphenyl]benzotriazole, 2-[2′-hydroxy-4′-(2″-ethylheptyl)oxyphenyl]benzotriazole, 2-[2′-hydroxy-4′-(2″-ethyloctyl)oxyphenyl]benzotriazole, 2-[2′-hydroxy-4′-(2″-propyloctyl)oxyphenyl]benzotriazole, 2-[2′-hydroxy-4′-(2″-propylheptyl)oxyphenyl]benzotriazole, 2-[2′-hydroxy-4′-(2″-propylhexyl)oxyphenyl]benzotriazole, 2-[2′-hydroxy-4′-(1″-ethylhexyl)oxyphenyl]benzotriazole, 2-[2′-hydroxy-4′-(1″-ethylheptyl)oxyphenyl]benzotriazole, 2-[2′-hydroxy-4′-(1″-ethyloctyl)oxyphenyl]benzotriazole, 2-[2′-hydroxy-4′-(1″-propyloctyl)oxyphenyl]benzotriazole, 2-[2′-hydroxy-4′-(1″-propylheptyl)oxyphenyl]benzotriazole, 2-[2′-hydroxy-4′-(1″-propylhexyl)oxyphenyl]benzotriazole, 2-(2′-hydroxy-3′-sec-butyl-5′-tert-butylphenyl)-5-n-butylbenzotriazole, 2-(2′-hydroxy-3′-sec-butyl-5′-tert-butylphenyl)-5′-tert-pentylbenzotriazole, 2-(2′-hydroxy-3′-sec-butyl-5′-tert-butylphenyl)-S-n-pentylbenzotriazole, 2-(2′-hydroxy-3′-sec-butyl-5′-tert-pentylphenyl)-5′-tert-butylbenzotriazole, 2-(2′-hydroxy-3′-sec-butyl-5′-tert-pentylphenyl)-5′-n-butylbenzotriazole, 2-(2′-hydroxy-3′,5′-di-tert-butylphenyl)-5-sec-butylbenzotriazole, 2-(2′-hydroxy-3′,5′-di-tert-pentylphenyl)-5-sec-butylbenzotriazole, 2-(2′-hydroxy-3′-tert-butyl-5′-tert-pentylphenyl)-5-sec-butylbenzotriazole, 2-(2′-hydroxy-3,5′-di-sec-butylphenyl)-5-chlorobenzotriazole, 2-(2′-hydroxy-3,5′-di-sec-butylphenyl)-S-methoxybenzotriazole, 2-(2′-hydroxy-3,5′-di-sec-butylphenyl)-5-tert-butylbenzotriazole, 2-(2′-hydroxy-3,5′-di-sec-butylphenyl)-5-n-butylbenzotriazole, octyl-5-tert-butyl-3-(5-chloro-2H-benzotriazole-2-yl)-4-hydroxybenzene propionate, condensate of methyl-3-[tert-butyl-S-(2H-benzotriazole-2-yl)-4-hydroxyphenyl]propionate and polyethylene glycol (molecular weight: about 300) and like benzotriazole ultraviolet absorbers.

The heat sensitive recording material of the invention can be prepared according to conventional methods. For example, at least one colour forming compound, at least one developer, at least one sensitiser are ground separately in water or a suitable dispersing medium, such as aqueous polyvinyl alcohol, to form an aqueous or other dispersion. A compound of formula I, II or III is treated in the same manner. The fine particle dispersions thus obtained are combined and then mixed with conventional amounts of binder, filler and lubricant.

The coating liquid so obtained can be applied to a suitable substrate such as paper, plastic sheet and resin coated paper, and used as the heat sensitive recording material. The system of the invention can be employed for other end use applications using colour forming materials, for example, a temperature indicating material.

The quantity of the coating is usually in the range of 2 to 10 g/m², most often in the range 4 to 8 g/m².

The recording material containing such a thermosensitive colouring layer can in addition contain a protective layer and, if desired, an undercoat layer. The undercoat layer may be interposed between the substrate and the thermosensitive colouring layer.

The protective layer usually comprises a water-soluble resin in order to protect the thermosensitive colouring layer. If desired, the protective layer may contain water-soluble resins in combination with water-insoluble resins.

As such resins conventional resins can be employed. Specific examples are: polyvinyl alcohol; starch and starch derivatives; cellulose derivatives such as methoxycellulose, hydroxyethylcellulose, carboxymethylcellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polyesters and carboxyl-group-modified polyvinyl alcohols.

The protective layer may also contain a water-resisting agent such as a polyamide resin, polyamido-epichlorhydrin resin, melamine-formaldehyde resin, formaldehyde, glyoxal or chromium alum.

Furthermore, the protective layer may contain fillers, such as finely-divided inorganic powders, e.g. of calcium carbonate, silica, zinc oxide, titanium oxide, aluminium hydroxide, zinc hydroxide, barium sulphate, clay, talc, surface-treated calcium or silica, or a finely-divided organic powder of, e.g., a urea-formaldehyde resin, a styrene/methacrylic acid copolymer or polystyrene.

The undercoat layer usually contains as its main components a binder resin and a filler. Specific examples of binder resins for use in the undercoat layer are: polyvinyl alcohol; starch and starch derivatives; cellulose derivatives such as methoxycellulose, hydroxyethylcellulose, carboxymethylcellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polymers such as water-soluble polyesters and carboxyl-group-modified polyvinyl alcohols; polyvinyl acetate; polyurethanes; styrene/butadiene copolymers; polyacrylic acid; polyacrylic acid esters; vinyl chloride/vinyl acetate copolymers; polybutylmethacrylate; ethylene/vinylacetate copolymers and styrene/butadiene acrylic derivative copolymers.

Specific examples of fillers for use in the undercoat layer are: finely-divided inorganic powders, e.g. of calcium carbonate, silica, zinc oxide, titanium oxide, aluminium hydroxide, zinc hydroxide, barium sulphate, clay, talc, surface-treated calcium, silica or calcined clay (e.g. Ansilex, Engelhard Corp.), and finely-divided organic powders of, e.g., urea-formaldehyde resins, styrene/methacrylic acid copolymers and polystyrene.

In addition, the undercoat layer may contain a water-resisting agent. Examples of such agents are given above.

In particular the invention provides exceptional resistance to plasticiser, oil and heat ageing whilst showing improved background whiteness.

### EXAMPLES

Preparation of heat sensitive coating formulations containing a stabiliser as defined herein:

Dispersions A to D are prepared by grinding the compositions shown below in an attritor until an average particle size of 1 to 1.5μ is attained.

| | |
|---|---|
| Dispersion A (Colour Former) | |
| 3-dibutylamino-6-methyl-7-anilinofluoran | 3.01 parts |
| Polyvinyl alcohol (10% aqueous solution) | 10.50 parts |
| Water | 6.49 parts |
| Dispersion B (Colour Developer) | |
| Colour developer | 7.50 parts |
| Polyvinyl alcohol (10% aqueous solution) | 7.50 parts |
| Water | 22.50 parts |
| Dispersion C (Sensitiser) | |
| Sensitiser | 10.00 parts |
| Polyvinyl alcohol (10% aqueous solution) | 10.00 parts |
| Water | 20.00 parts |
| Dispersion D (Stabiliser) | |
| Stabiliser | 7.50 parts |
| Polyvinyl alcohol (10% aqueous solution) | 7.50 parts |
| Water | 22.50 parts |

A thermal coating mixture is then prepared by combining together the following components:

| | parts by weight |
|---|---|
| Dispersion A | 6.6 |
| Dispersion B | 12.5 |
| Dispersion C | 6.0 |
| Dispersion D | 2.5 |
| Calcium Carbonate (25% aqueous dispersion) | 13.2 |
| Zinc stearate (33% aqueous dispersion) | 1.5 |
| Polyvinyl alcohol (10% aqueous solution) | 6.5 |
| Tinopal ® ABP-X (fluorescent | 0.12 |
| whitening agent) | |
| Water | 2.58 |

This coating mixture is applied on one side of a base paper weighing 50 g/m² in a coating weight of about 5.0 g/m² and then dried. The resulting sheet is calandered by means of a laboratory calander to produce a recording sheet with excellent background whiteness.

Description of Test Methods

Lightfastness Tests (120 Hours Exposure):

This test assesses the stability of the imaged and un-imaged thermal paper to sunlight.

An image is produced using an Atlantek thermal response tester model 200. The image including background is placed at a distance of 8 cm below 40 W fluorescent tubes emitting artificial sunlight (approximately 1200 Lux) for 120 hours. The optical density of the image and background whiteness of the paper are measured before and after exposure with a Macbeth 1200 series Densitometer.

Cottonseed Oil Resistance of Image:

This test assesses the stability of the image when exposed to cottonseed oil.

An image is produced using an Atlantek thermal response tester model 200. Cottonseed oil is then gravure printed onto the image, which is then stored at 40° C. for 24 hours. The optical density of the image is measured using a Macbeth 1200 series Densitometer before and after exposure.

Plasticiser Resistance of Image and Background:

This test assesses the stability of the image and background when exposed to PVC containing 20-25% phthalate ester-type plasticiser.

An image is produced using an Atlantek thermal response tester model 200. The image is put into contact with the PVC under 107 g cm⁻² pressure for 24 hours at 50° C. The optical density of the image and background are measured using a Macbeth 1200 series Densitometer before and after exposure.

Waterfastness of Image:

This test assesses the stability of the image after immersion in water.

An image is produced using an Atlantek thermal response tester model 200. The image is immersed in de-ionised water at room temperature for 3 hours. The optical density of the image is measured using a Macbeth 1200 series Densitometer before and after immersion.

Heat and Moisture Resistance of Image:

This test assesses the effects of heat and moisture on the image.

An image is produced using an Atlantek thermal response tester model 200. The image is aged at 60° C. at 70% R.H. for 24 hours. The optical density of the image is measured using a Macbeth 1200 series Densitometer before and after exposure.

### Example 1

A coating mixture is prepared using N-p-toluenesulphonyl-N′-[3-O-p-toluenesulphonyl]phenyl urea as stabiliser (Dispersion D) with 2,4′-dihydroxydiphenylsulphone as developer (Dispersion B) and di-(p-methylbenzyl)oxalate as sensitiser (Dispersion C).

The heat sensitive recording paper obtained demonstrates good background whiteness of the paper after application of the coating liquid and also after carrying out storage stability i.e. resistance to light, heat and moisture, of the uncoloured portion of the coated paper. Image stability is excellent and the performance against thermal paper coated without a stabiliser is summarised in Table 1. Additionally the recording paper obtained shows a high dynamic sensitivity.

### Example 2

A coating mixture was prepared as described in Example 1, but the quantity of stabiliser is reduced by 50%.

### Example 3

A coating mixture is prepared as described in Example 1, but the quantity of stabiliser is reduced by 80%.

### Example 4

A coating mixture is prepared using N-p-toluenesulphonyl-N′-[3-O-p-toluenesulphonyl]phenyl urea as stabiliser (Dispersion D) with 2,2-bis-(4-hydroxyphenyl)-4-methylpentane as developer (Dispersion B) and p-benylbiphenyl as sensitiser (Dispersion C).

### Example 5

A coating mixture is prepared using N-p-toluenesulphonyl-N′-[3-O-p-toluenesulphonyl]phenyl urea as stabiliser (Dispersion D) with 2,2-bis-(4-hydroxyphenyl)-4-methylpentane as developer (Dispersion B) and 1,2-diphenoxyethane as sensitiser (Dispersion C).

### Example 6

A coating mixture is prepared using N-p-toluenesulphonyl-N′-[3-O-p-toluenesulphonyl]phenyl urea as stabiliser (Dispersion D) with a mixture of 3-dibutylamino-6-methyl-7-anilinofluoran and 3-diethylamino-6-methyl-7-anilinofluoran in the ratio of 30:70 as colour former (Dispersion A), 2,2-bis-(4-hydroxyphenyl)-4-methylpentane as developer (Dispersion B) and p-benzylbiphenyl as sensitiser (Dispersion C).

### Example 7

A coating mixture is prepared using N-p-toluenesulphonyl-N′-[3-O-p-toluenesulphonyl]phenyl urea as stabiliser (Dispersion D) with a mixture of 3-dibutylamino-6-methyl-7-anilinofluoran and 3-diethylamino-6-methyl-7-anilinofluoran in the ratio of 30:70 as colour former (Dispersion A), 2,2-bis-(4-hydroxyphenyl)-4-methylpentane as developer (Dispersion B) and 1,2-diphenoxyethane as sensitiser (Dispersion C).

### Example 8

A coating mixture is prepared using N-p-toluenesulphonyl-N′-[3-carboxyphenyl]urea as stabiliser (Dispersion D) with bisphenol A as developer (Dispersion B) and p-benzylbiphenyl as sensitiser (Dispersion C).

### Example 9

A coating mixture is prepared using N-p-toluenesulphonyl-N′-[3-carboxyphenyl]urea as stabiliser (Dispersion D) with 4-hydroxy-4′-isopropoxy-diphenylsulphone as developer (Dispersion B) and p-benzylbiphenyl as sensitiser (Dispersion C).

### Example 10

A coating mixture is prepared using N-p-toluenesulphonyl-N′-[3-carboxyphenyl]urea as stabiliser (Dispersion D) with 2,4′-dihydroxydiphenylsulphone as developer (Dispersion B) and di-(p-methylbenzyl)oxalate as sensitiser (Dispersion C).

TABLE 1

| | | | Heat and | | | |
|---|---|---|---|---|---|---|
| | Initial Image | | Moisture | Plasticiser | Cottonseed Oil | Water |
| Example | Density | Lightfastness | Resistance | resistance | resistance | Fastness |
| 1 | + | ◯ | ++ | ++ | ++ | ◯ |
| 2 | + | ◯ | + | ++ | ++ | ◯ |
| 3 | + | ◯ | ◯ | ++ | ++ | ◯ |
| 4 | ◯ | ◯ | + | ++ | ++ | ◯ |
| 5 | ◯ | ◯ | ++ | ++ | ++ | ◯ |
| 6 | ◯ | ◯ | ◯ | ++ | ++ | ◯ |
| 7 | ◯ | ◯ | ◯ | + | + | ◯ |
| 8 | ◯ | ◯ | + | + | ++ | ++ |
| 9 | ◯ | + | + | + | ++ | ++ |
| 10 | ◯ | + | + | + | ++ | + |

Key:
◯ Similar performance when compared to against thermal paper coated without a stabiliser.
+ Improved performance when compared to against thermal paper coated without a stabiliser.
++ Superior performance when compared to against thermal paper coated without a stabiliser.

### Example 11

A coating mixture is prepared using N-(p-toluenesulphonyl)-N′-(pyrid-3-yl)urea as stabiliser (Dispersion D) with 2,4′-dihydroxydiphenylsulphone as developer (Dispersion B) and di-(p-methylbenzyl)oxalate as sensitiser (Dispersion C).

The heat sensitive recording paper obtained demonstrates good background whiteness of the paper after application of the coating liquid and also after carrying out storage stability i.e. resistance to light, heat and moisture, of the uncoloured portion of the coated paper. Image stability is excellent and the performance against thermal paper coated without a stabiliser is summarised in Table 2. Additionally the recording paper obtained shows a high dynamic sensitivity.

### Example 12

A coating mixture is prepared using N-(p-toluenesulphonyl)-N′-(6-methylpyidin-2-yl)urea as stabiliser (Dispersion D) with 2,4′-dihydroxydiphenylsulphone as developer (Dispersion B) and di-(p-methylbenzyl)oxalate as sensitiser (Dispersion C).

### Example 13

A coating mixture is prepared using N-(p-toluenesulphonyl)-N′-(5-methylisoxazol-3-yl)urea as stabiliser (Dispersion D) with 2,4′-dihydroxydiphenylsulphone as developer (Dispersion B) and di-(p-methylbenzyl)oxalate as sensitiser (Dispersion C).

### Example 14

A coating mixture is prepared using N-(p-toluenesulphonyl)-N′-((1,2-dihydro-1,5-dimethyl-2-phenyl-3H-pyrazol-3-one)₄-yl)urea as stabiliser (Dispersion D) with 2,4′-dihydroxydiphenylsulphone as developer (Dispersion B) and di-(p-methylbenzyl)oxalate as sensitiser (Dispersion C).

### Example 15

A coating mixture is prepared using N-(p-toluenesulphonyl)-N′-(1.H.-indazol-6-yl)urea as stabiliser (Dispersion D) with 2,4′-dihydroxydiphenylsulphone as developer (Dispersion B) and di-(p-methylbenzyl)oxalate as sensitiser (Dispersion C).

### Example 16

A coating mixture is prepared using N-(p-toluenesulphonyl)-N′-(4,6-dimethylpyrimidin-2-yl)urea as stabiliser (Dispersion D) with 2,4′-dihydroxydiphenylsulphone as developer (Dispersion B) and di-(p-methylbenzyl)oxalate as sensitiser (Dispersion C).

### Example 17

A coating mixture is prepared using N-(p-toluenesulphonyl)-N′-(benzothiazol-2-yl)urea as stabiliser (Dispersion D) at a reduced level of 50% with 2,4′-dihydroxydiphenylsulphone as developer (Dispersion B) and di-(p-methylbenzyl)oxalate as sensitiser (Dispersion C).

### Example 18

A coating mixture is prepared using N-(p-toluenesulphonyl)-N′-(thiazol-2-yl)urea as stabiliser (Dispersion D) at a reduced level of 50% with 2,4′-dihydroxydiphenylsulphone as developer (Dispersion B) and di-(p-methylbenzyl)oxalate as sensitiser (Dispersion C).

### Example 19

A coating mixture is prepared using N-(p-toluenesulphonyl)-N′-(5-methyl-1.H.-pyrazol-3-yl)urea as stabiliser (Dispersion D) with 2,4′-dihydroxydiphenylsulphone as developer (Dispersion B) and di-(p-methylbenzyl)oxalate as sensitiser (Dispersion C).

### Example 20

A coating mixture is prepared using N-(p-toluenesulphonyl)-N′-(benzimidazol-2-yl)urea as stabiliser (Dispersion D) with 2,4′-dihydroxydiphenylsulphone as developer (Dispersion B) and di-(p-methylbenzyl)oxalate as sensitiser (Dispersion C).

### Example 21

A coating mixture is prepared using N-(p-toluenesulphonyl)-N′-(pyrimidin-2-yl)urea as stabiliser (Dispersion D) with 2,4′-dihydroxydiphenylsulphone as developer (Dispersion B) and di-(p-methyl benzyl)oxalate as sensitiser (Dispersion C).

### Example 22

A coating mixture is prepared using N-(p-toluenesulphonyl)-N′-(6-methanesulphonylbenzothiazol-2-yl)urea as stabiliser (Dispersion D) with 2,4′-dihydroxydiphenylsulphone as developer (Dispersion B) and di-(p-methylbenzyl)oxalate as sensitiser (Dispersion C).

### Example 23

A coating mixture is prepared using, N-(p-toluenesulphonyl)-N′-[4-(6-methylbenzothiazol-2-yl)phenyl]urea as stabiliser (Dispersion D) with 2,4′-dihydroxydiphenylsulphone as developer (Dispersion B) and di-(p-methylbenzyl)oxalate as sensitiser (Dispersion C).

### Example 24

A coating mixture is prepared using N-(p-toluenesulphonyl)-N′-(1H-[1,2,4]triazol-3-yl)urea as stabiliser (Dispersion D) with 2,4′-dihydroxydiphenylsulphone as developer (Dispersion B) and di-(p-methylbenzyl)oxalate as sensitiser (Dispersion C).

TABLE 2

| | | | Heat and | | Cottonseed | |
|---|---|---|---|---|---|---|
| | Initial Image | | Moisture | Plasticiser | Oil | Water |
| Example | Density | Lightfastness | Resistance | resistance | resistance | Fastness |
| 11 | 0 | 0 | + | + | + | 0 |
| 12 | 0 | 0 | ++ | ++ | ++ | 0 |
| 13 | 0 | 0 | + | + | ++ | 0 |
| 14 | 0 | 0 | + | + | ++ | 0 |
| 15 | 0 | 0 | ++ | + | ++ | 0 |
| 16 | 0 | 0 | + | + | + | 0 |
| 17 | 0 | 0 | ++ | + | ++ | 0 |
| 18 | 0 | 0 | ++ | + | + | 0 |
| 19 | 0 | 0 | ++ | ++ | ++ | 0 |
| 20 | 0 | 0 | ++ | + | + | 0 |
| 21 | 0 | 0 | ++ | ++ | 0 | 0 |
| 22 | 0 | 0 | ++ | ++ | + | 0 |
| 23 | 0 | 0 | ++ | ++ | ++ | 0 |
| 24 | 0 | 0 | ++ | + | 0 | 0 |

Key:
0 Similar performance when compared to against thermal paper coated without a stabiliser.
+ Improved performance when compared to against thermal paper coated without a stabiliser.
++ Superior performance when compared to against thermal paper coated without a stabiliser.

1. Composition comprising
a) a colour former compound,
b) a developer, which is different from the stabilizer used as component c),
c) a stabilizer, selected from the group consisting of compounds having the formulae I, II and III, 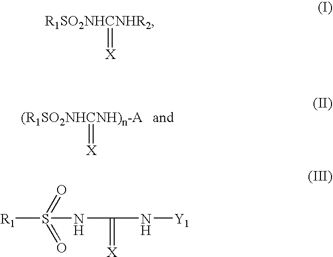
wherein
R₁ stands for unsubstituted or substituted phenyl or naphthyl, C₁-C₂₀alkyl, C₃-C₁₀cycloalkyl, wherein the carbon chains of the C₂-C₂₀alkyl and C₃-C₁₀cycloalkyl groups may be interrupted by —O—, —S—, —NH-radicals, or
unsubstituted or substituted aralkyl having from seven to twelve carbon atoms,
R₂ stands for hydrogen, unsubstituted or substituted phenyl, naphthyl, C₁-C₂₀alkyl, or unsubstituted or substituted aralkyl having from seven to twelve carbon atoms,
or R₂ stands for —R₃-B-R₄, in which R₃ stands for phenylene or naphthylene and wherein B stands for —O—SO₂—, —SO₂—O—, —NH—SO₂—, —SO₂—NH—, —S—SO2—, —O—CO—, —O—CO—NH—, —NH—CO—, —NH—CO—O—, —S—CO—NH—, —S—CS—NH—, —CO—NH—SO₂—, —O—CO—, —NH—SO₂—, —NH═CH—, —CO—NH—CO—, —S—, —CO—, —O—, —SO₂—NH—CO—, —O—CO—O—, —CH₂—, —CH₂CH₂—, —SO₂—, —O—PO—(OR₄)₂, —CONH— or —COO—,
and R₄ stands for hydrogen, C₆-C₁₀aryl, which can be unsubstituted or substituted one to three times by C₁-C₈alkyl, halogen-substituted C₁-C₈alkyl, C₁-C₈ alkoxy-substituted C₁-C₈ alkyl, C₁-C₈alkoxy, halogen-substituted C₁-C₈ alkoxy or halogen,
benzyl, wherein the benzyl is unsubstituted or substituted one to three times by C₁-C₈alkyl, halogen-substituted C₁-C₈alkyl, C₁-C₈alkoxy-substituted C₁-C₈alkyl, C₁-C₈alkoxy, halogen-substituted C₁-C₈ alkoxy or halogen,
or C₁-C₂₀alkyl wherein the C₁-C₂₀ alkyl can be unsubstituted or substituted one to three times by C₁-C₈alkoxy, halogen, or halogen-substituted C₁-C₆alkyl,
A represents a multivalent group having a valency of 2, 3 or 4,
n represents an integer of 2, 3 or 4, and
X stands for oxygen or sulphur,
Y₁ stands for a heterocyclic ring having from two to seven carbon atoms and from 1 to three atoms selected from the group consisting of oxygen, nitrogen and sulphur, which can be substituted one to three times with unsubstituted or substituted phenyl, C₁-C₂₀alkyl, C₁-C₈alkoxy, halogen or —SO₂R₆,
R₆ stands for phenyl, which may be substituted one to three times with C₁-C₄alkyl, wherein the total number of carbon, oxygen, sulphur and nitrogen atoms of the heterocyclic ring is from 5 to 9,
and wherein the amount of the stabilizer is less than 5% by weight, based on the total weight of the composition.

2. Heat-sensitive recording material comprising:
a substrate sheet, and
a heat-sensitive coloured image-forming layer formed on the surface of the substrate sheet and comprising the composition of claim 1.

3. (canceled).

4. A stabilizer according to claim 1, wherein
R₃ is o-, m- or p-phenylene, or 1,2; 2,3; 1,4 or 1,5-naphthylene,
B is —O—SO₂—, —SO₂—O—, —SO₂—NH—, —S—SO₂—, —O—CO—, —SO₂—, —CH₂—, —O—CO—NH—, —CONH—, —O— or —COO—,
and R₄ is phenyl wherein the phenyl is unsubstituted or substituted by C₁-C₈ alkyl, halogen-substituted C₁-C₈alkyl, C₁-C₈alkoxy-substituted C₁-C₈alkyl, C₁-C₈alkoxy, halogen-substituted C₁-C₈alkoxy or halogen, or
unsubstituted naphthyl.

5. A stabilizer according to claim 1, wherein R₃ is p-phenylene or 1,5-naphthylene
B stands for O—SO₂—, —SO₂—O—, —O—CO—, SO2—, —O— or —SO₂—NH—
and R₄ is phenyl which is unsubstituted or substituted by C₁-C₄alkyl.

6. A stabilizer according to claim 1, wherein R₃ is phenyl, wherein the phenyl is substituted by C₁-C₆ alkyl
or naphthyl, wherein the naphthyl is substituted by C₁-C₆ alkyl.

7. A method of manufacturing a heat-sensitive recording material comprising
mixing a composition according to claim 1 into a coating and
applying said coating onto a substrate to form a heat-sensitive coloured image-forming layer.

8. A heat-sensitive recording material according to claim 2, wherein the substrate sheet is selected from the group consisting of paper, synthetic paper and plastic resin film.

9. A temperature indicating material comprising a composition according to claim 1.
